(19) United States
(12) Patent Application Publication
(10) Pub. No.: US 2015/0081051 A1
(43) Pub. Date: Mar. 19, 2015

(54) METHOD AND SYSTEM FOR DESIGNING A CONTROL SOFTWARE PRODUCT FOR INTEGRATION WITHIN AN EMBEDDED SYSTEM OF A POWER ELECTRONICS SYSTEM

(71) Applicant: ALIZEM INC., LEVIS (CA)

(72) Inventor: Marc Perron, Levis (CA)

(73) Assignee: ALIZEM INC., LEVIS (CA)

(21) Appl. No.: 14/397,239

(22) PCT Filed: May 30, 2013
(86) PCT No.: PCT/CA2013/000545

§ 371 Date: Oct. 27, 2014

Related U.S. Application Data
(60) Provisional application No. 61/655,667, filed on Jun. 5, 2012.

(51) Int. Cl. G05B 15/02; G06F 9/45; G06F 9/44

(52) U.S. Cl. CPC G05B 15/02; G06F 8/30; G06F 8/41
USPC 700/86

(57) ABSTRACT

There is described a method for designing a control software product for integration with a main application of an embedded system adapted to control a power electronic component in a power electronic system, the method comprising: generating software source code comprising a control algorithm being specific to an application of the power electronic component, a power converter load, and an application of the power converter load, the control algorithm comprising at least one control function for determining operation parameters for the power electronic component according to a desired parameter; compiling the software source code, thereby obtaining a compiled file; generating a software interface for interfacing the compiled file with the main application, the software interface file comprising a definition of the at least one control function; and outputting the compiled file and the software interface.

### CROSS-REFERENCE TO RELATED APPLICATIONS

This patent application claims priority on U.S. Provisional Patent Application No. 61/655,667, filed on Jun. 5, 2012, and is entitled “Method and system for designing a control software product for integration within an embedded system of a power electronics system”, the specification of which is hereby incorporated by reference.

### TECHNICAL FIELD

The present invention relates to the field of embedded systems used in power electronics systems, and more particularly to methods and system for designing Commercial-Off-The-Shelf (COTS) control software products ready for integration within embedded systems.

### BACKGROUND

In the field of power electronics, embedded systems are used for controlling power electronics devices states (ON or OFF) within a power electronics system such as those of a power converter for example. In the case of a power converter used for powering an electric motor, the embedded system is adapted to control the state of the motor via the control of the state of the power electronics devices of the power converter.

Usually a designer of an embedded system for power electronics systems designs his own power converter/motor control software. While he may use publicly available motor control algorithm, the designer needs to have particular expertise in both power electronics and embedded system programming to achieve successful system development, which may be difficult to have. Furthermore, developing such embedded systems for power electronics systems can be time consuming and expensive. Also, even though a publicly available software component might be reputed for achieving correct performance, system bugs may be found on the hardware side of the system, e.g. power electronic devices, sensors, system protection, and the like, and are therefore tested prior enabling motor control functions in order to prevent any system fault, failure, damage or personnel injury.

Therefore, there is a need for an improved method and system for designing control software products that are ready for integration within embedded systems of power electronics systems.

### BRIEF SUMMARY

According to a first broad aspect, there is provided a method for designing a control software product for integration with a main software application of an embedded system adapted to control a power converter in a power electronic system, the method comprising: generating software source code comprising a control algorithm being specific to a topology of the power converter, a power converter load, and an application of the power converter load, the control algorithm comprising at least one control function for determining a state for the power converter according to a desired parameter; compiling or encrypting the software source code, thereby obtaining a compiled file; generating a software interface for interfacing the compiled file with the main application, the software interface file comprising a definition of the at least one control function; and outputting the compiled file and the software interface.

In one embodiment, the power converter is an inverter.

In one embodiment, the application of the power converter comprises powering an electric motor, the control algorithm being specific to the electric motor and an application of the electric motor.

In one embodiment, the desired parameter is specific to the electric motor.

In one embodiment, the desired parameter comprises one of a speed, a position, a torque, and an acceleration.

In one embodiment, the method further comprises generating an open code file comprising second software source code corresponding to user-defined functions specific to the power electronic system, the second software source code being modifiable by a user to adapt the user-defined functions to the power electronic system.

In one embodiment, the power electronic system comprises at least one sensor for monitoring at least one operating parameter, the user-defined functions being specific to the sensor.

In one embodiment, the software source code comprises a function for automatically shutting off the power electronic system after a predetermined period of time.

According a second broad aspect, there is provided an embedded system for controlling a power converter in a power electronic system, comprising: a processing unit; and a memory having stored therein: a compiled or encrypted file comprising a control algorithm being specific to a topology of the power converter, a power converter load, and an application of the power converter load, the control algorithm comprising at least one control function for determining a state for the power converter according to a desired parameter; a main application for receiving the desired parameter and outputting the determined state for the power converter; and a software interface for interfacing the compiled file with the main application, the software interface file comprising a definition of the at least one control function.

In one embodiment, the application of the power converter comprises powering an electric motor, the control algorithm being specific to the electric motor and an application of the electric motor.

In one embodiment, the embedded system further comprises an open code file comprising second software source code corresponding to user-defined functions specific to the power electronic system, the second software source code being modifiable by a user to adapt the user-defined functions to the power electronic system.

In one embodiment, the power electronic system comprises at least one sensor for monitoring at least one operating parameter, the user-defined functions being specific to the at least one sensor.

According to a further broad aspect, there is provided an embedded system for controlling a power converter in a power electronic system, comprising: a processing unit; and a memory having stored therein: first software code comprising a control algorithm being specific to a topology of the power converter, a power converter load, and an application of the power converter load, the control algorithm comprising at least one control function for determining a state for the power converter according to a desired parameter; second software code comprising at least a test function for testing at least one property of the power electronic system; a main application for receiving the desired parameter and outputting the determined state for the power converter; and a software interface for interfacing the compiled file with the main application, the software interface file comprising a definition of the at least one control function.

In one embodiment, the application of the power converter comprises powering an electric motor, the control algorithm being specific to the electric motor and an application of the electric motor.

In one embodiment, the embedded system further comprises open software source code corresponding to user-defined functions specific to the power electronic system, the open software source code being modifiable by a user to adapt the user-defined functions to the power electronic system.

### BRIEF DESCRIPTION OF THE DRAWINGS

Further features and advantages of the present invention will become apparent from the following detailed description, taken in combination with the appended drawings, in which:

FIG. 1 is a block diagram of a power electronic system comprising a power converter for powering an electric motor and an embedded system for controlling the power converter, in accordance with an embodiment;

FIG. 2 is a block diagram of the embedded system of FIG. 1 which comprises a hardware portion and a software portion, the software portion comprising a main application component and a power converter control software component, in accordance with an embodiment;

FIG. 3 is a block diagram of the power converter control software component of FIG. 2, in accordance with an embodiment;

FIG. 4 is a flow chart of a method for designing a software control product for integration in an embedded system of a power electronics system, in accordance with an embodiment;

FIG. 5 is a block diagram illustrating a power converter control software component for controlling an electric motor having a low-dynamics load such as a fan or a pump for example, in accordance with an embodiment;

FIG. 6 illustrates a three-phase two-level inverter, in accordance with an embodiment;

FIG. 7 a block diagram illustrating a power converter control software component for controlling a single electric motor used in high dynamics application such as a servo-drive application, in accordance with an embodiment; and

FIG. 8 a block diagram illustrating a power converter control software component for controlling three electric motors used in a servo-drive application, in accordance with an embodiment.

It will be noted that throughout the appended drawings, like features are identified by like reference numerals.

### DETAILED DESCRIPTION

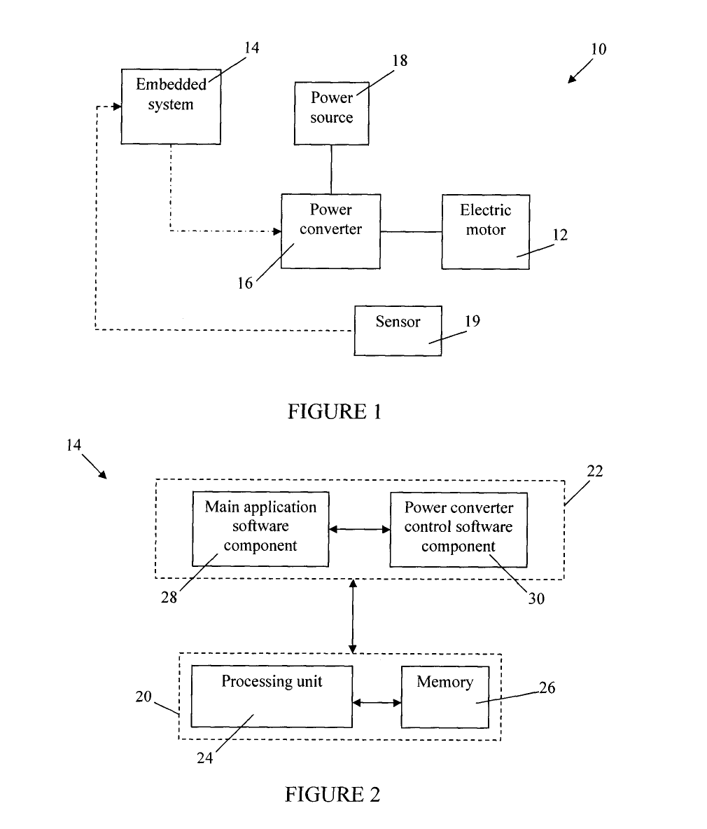

FIG. 1 illustrates one embodiment of a power electronic system 10 in which electrical power conversion is to be controlled by an embedded system.

The power electronic system 10 comprises at least an electric motor 12, an embedded system 14, and a power converter 16. The embedded system 14 is adapted to control at least the power converter 16 which powers the electric motor 12. The power converter 16 is connectable to a power source 18 and is adapted to convert the electrical energy provided by the power source 18 into adequate electrical energy for powering the electric motor. The power converter 16 may convert Alternating Current (AC) to or from Direct Current (DC), the amplitude or frequency of the current, or any combination thereof, depending of the motor type.

The embedded system 14 is adapted to receive a command indicative of a desired state for the motor and control the individual states of the power electronic components forming the power converter 16, using a Pulse-Width Modulation (PWM) signal for example, according to the received command. The embedded system 14 determines the powering conditions or requirements, i.e. an AC or DC voltage, an AC or DC current intensity, an AC current frequency, and/or the like, to be applied to the electric motor 12 and adjusts the power converter 16 so as to provide the electric motor with the determined powering conditions, i.e. the determined AC or DC voltage, AC or DC current intensity, AC current frequency, and/or the like.

In one embodiment, the command is received from an end user of the power electronic system 10. For example, the power electronic system 10 may be provided with a user interface through which an end user may enter commands. In another example, the power electronic system 10 may be provided with a communication unit for remotely receiving commands from an end user.

In another embodiment, the command may be generated automatically by the embedded system 14. For example, the main application software component of a washing machine may be adapted to determine a desired motor speed from a command indicative of a desired wash cycle.

In one embodiment, the embedded system 14 receives a command indicative of a desired state value for the motor 12. In this case, the embedded system determines the powering conditions to be applied to the electric motor 12 in order to obtain the desired state value and transmits a PWM command signal indicative of the determined powering conditions to the power converter 16. This PWM signal commands a specific set of states of the power electronics components of the power converter 16 which powers the electric motor 12 accordingly, i.e. the power converter 16 modifies the voltage to be applied on the electric motor phases and therefore the electrical current provided by the power source 18 to power the electric motor 12 with the adequate AC or DC voltage, AC or DC current intensity, AC current frequency, and/or the like for obtaining the desired state value for the electric motor 12.

In one embodiment, the desired state of the electric motor 12 to be adjusted comprises at least one of: a speed, a position, a torque, an acceleration, and/or the like. In this case, the command received by the embedded system 14 may be indicative of the desired speed, position, torque, acceleration, etc, for the motor.

In an embodiment comprising an AC electric motor, the frequency and the intensity of the AC electrical voltage provided by the power converter 16 may be adjusted to control the speed of the electric motor. In this case, the embedded system 14 is adapted to receive a command indicative of a desired speed and determine a corresponding frequency and intensity for the electrical voltage to be applied to the electric motor 12. Then, the embedded system 14 is adapted to transmit a pulse-width modulation (PWM) command indicative of the corresponding voltage frequency and intensity to the power converter 16 provided to the electric motor 12 to the corresponding frequency in order to adjust the speed of the electric motor 12 to the desired speed. This approach is known as scalar control of an electric motor or “V/Hz” control.

In another embodiment, the AC voltage applied to an AC electric motor may be adjusted to control the torque of the AC electric motor. In this case, the embedded system 14 is adapted to receive a command indicative of a desired torque for the motor 12 and determine a corresponding voltage of the electrical current to be applied to the electric motor 12 based on electric motor rotor position and electric motor current phases values. Then, from those electric motor states values, the embedded system 14 calculates power converter state in a rotating reference frame—via Clarke's and Park's transformations, for example—and outputs a PWM command indicative of the desired state of the power converter 16 which applies the voltage provided to the electric motor 12 accordingly over time in order to control the current and therefore the torque of the electric motor 12. This approach is know as vector control of an electric motor or “field-oriented control”.

In one embodiment, the power electronic system 10 further comprises at least one sensor 19 for monitoring at least one system state thereof. In this case, the embedded system 14 is connected to the sensor 19 for at least receiving the monitored system state. In one embodiment, the embedded system 14 is adapted to determine the powering conditions to be applied to the electric motor 12 using the monitored system state. In the same or another embodiment, the embedded system 14 is adapted to trigger an alarm and/or take an action using the monitored system state. For example, the taken action may comprise actions such as stopping operation of the electric motor 12, reducing the speed/torque of the electric motor 12, or the like. For example, when the monitored system state reaches a predetermined threshold, i.e. when the monitored parameter becomes greater or lower than the predetermined threshold, the embedded system 14 triggers an alarm and/or stops operation of the electric motor 12.

In one embodiment, the sensor 19 is a temperature sensor for monitoring the temperature of at least one component of the motorized system 10 such as the power converter 16, the electric motor 12, and/or the like. In another embodiment, the sensor 19 is a current sensor for monitoring at least one parameter of the electrical current provided to the electric motor 12 by the power converter 16. For example, the sensor 19 may be a power meter for monitoring the electrical power delivered by the power converter 16, a current transducer for monitoring the intensity of the electrical current flowing into one phase of the electric motor 12, a voltage transducer for monitoring the voltage of the electrical current delivered by the power converter 16, or the like. In still a further embodiment, the sensor 19 may be adapted to monitor a state of the electric motor 12. For example, the sensor 19 may be a torque sensor for monitoring the torque of the electric motor 12, a position sensor for monitoring the position of the motor 12 or an element connected to and driven by the motor 12, a rotational speed sensor such as rotary encoder for example, for monitoring the rotational speed of the shaft of the electric motor 12.

In one embodiment, the embedded system 14 is further adapted to control elements of the system 10 other than the power converter 16. For example, the embedded system 14 may be adapted to control light indicators such as Light Emitting Diodes (LEDs) for example, display information on a display unit, receive and transmit information via a communication unit, etc.

It should be understood that a power electronic system may be any adequate system comprising at least one power electronic device used for controlling the electrical energy delivered by the power source and an embedded system for controlling at least one power converter. In one embodiment, the electronic power system can be a motorized system comprising at least one electric motor powered by the power converter and controlled by the embedded system via the power converter. Examples of motorized systems comprise washing machines, clothes dryers, dishwashers, robots, electric vehicles, vehicles power steering, vehicles braking system, Heating Ventilating and Air Conditioning (HVAC) systems, industrial servo-drives, medical respiratory devices, and the like.

It should be understood that the power converter 16 may be any adequate controller adapted to control the characteristics of electrical energy. For example, the power controller can be a power stage controller, a power supply, or the like. In the case of a motor controller application, the embedded software would then be known as motion control software rather than motor control software.

It should also be understood that the power source 18 may be any adequate source of electrical energy such as a grid, a battery, a solar energy generator, or the like. In one embodiment, the power source 18 comprises a rectifier connected to a grid for converting the AC current from the grid into DC current. In this case, the power converter 16 may be an inverter that converts the DC current received from the rectifier in an adequate AC current to power an AC motor for example.

FIG. 2 illustrates one embodiment of an embedded system 14 adapted to be used in the power electronic system 10. The embedded system 14 comprises a hardware portion 20 and an embedded software portion 22. The hardware portion 20 comprises a processing unit 24 and a storage unit 26 being connected together. The embedded software portion 22 comprises a main application software component 28 and a motor control software component 30, which are both stored on the storage unit 26. The embedded software 22 is then executed by the processing unit 24 for controlling the motorized system 10, and particularly the electric motor 12.

It should be understood that the storage unit 26 may be any adequate device for permanently or non-permanently storing digital data thereon. For example, the storing unit may be a volatile memory such as a Random-Access Memory (RAM), a Static Random-Access Memory (SRAM), a Dynamic Random-Access Memory (DRAM), or the like. In another example, the storage unit 26 may be a non-volatile memory such as a Read-Only Memory (ROM), a Field-Programmable Memory (FROM), an Electrically Erasable Programmable Read-Only Nemory (EEPROM), or the like.

It should be understood that the storage unit 26 and the processing unit 24 may be parts of a same device.

It should also be understood that the processing unit 24 may comprises a processor (soft or hard), some peripherals, some custom logic, some pins connected to the power converter, some pins connected to a sensor 19, and/or the like.

The main application software component 28 comprises the main application for the embedded system 14. The main application software component 28 comprises software code that, upon execution by the processing unit 24, is adapted to receive inputs, determine commands from the received inputs, and transmit the commands to the different components of the system 10 for controlling them. In an embodiment in which the power electronic system comprises at least one sensor, the main application software component is further adapted to receive the inputs coming from the sensor(s) and determine actions according to these inputs.

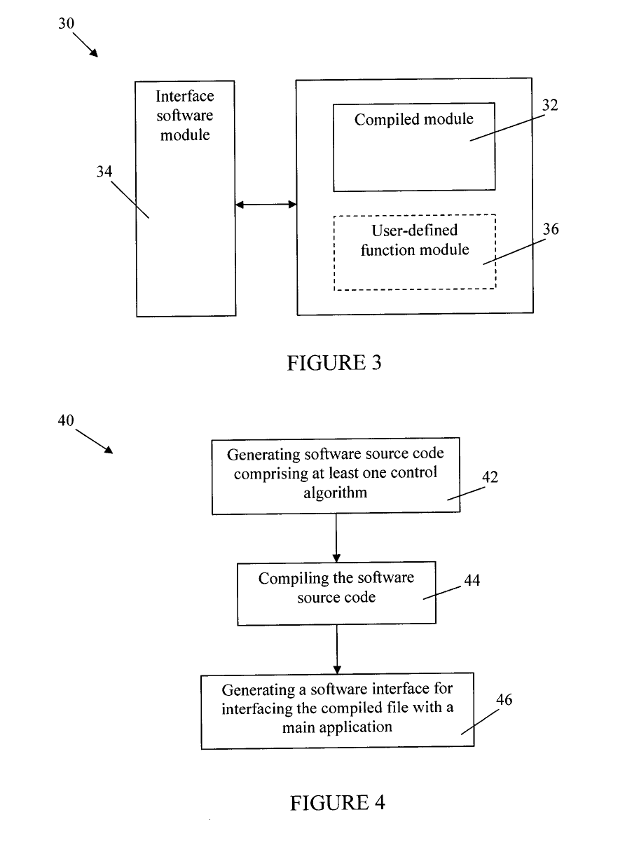

When determining the powering conditions for the electric motor 12, the main application software component 28 calls the motor control software component 30 illustrated in FIG. 3. The motor control software component 30 comprises at least one algorithm for controlling the power converter 16, i.e. an algorithm which comprises at least one function for determining the powering conditions for the electric motor 12. The main application software component 28 transmits a desired state for the electric motor 12, such as a desired speed, a desired position, a desired torque, or the like, to the motor control software component 30. The motor control software component 30 determines the corresponding powering conditions, i.e. the corresponding voltage, current intensity, current frequency, and/or the like, using the function contained in the algorithm and generates PWM signal commands indicative of the determined powering conditions and transmits the generated commands to the power converter 16 which powers the electric motor 12 according to the determined powering conditions.

In one embodiment, the main application software component 28 is further adapted to determine a desired state for the motor 12 using an input received from an end user. For example, the main application software component of a washing machine may be adapted to determine a desired motor speed from a command indicative of a desired wash cycle.

FIG. 3 illustrates one embodiment of a motor control software component 30 comprising a compiled software module 32 and an interface software module 34. The compiled software module 32 comprises at least one compiled file comprising at least one algorithm for determining the powering conditions for the electric motor 12 as a function of at least one desired parameter for the electric motor 12. The interface software module 34 is an Application Programming Interface (API) which allows the main application software component 28 and the compiled software module 32 to communicate together. The interface software module 34 comprises a definition for the function(s) comprised in the algorithm contained in the compiled module 32 so that the function(s) may be called by the main application software component 28.

For example, the compiled module 32 may comprise compiled software code for determining the powering conditions for the electric motor 12 as a function of a desired speed, e.g. a “set_speed” function. In this case, the “set_speed” function in contained in the compiled module 32 and defined and listed in the interface software module 34 so as to be called by the main application software component 28. The main application software component 28 receives a reference speed “ref_speed” for the motor 12 and calls the “set_speed” function from the interface software module 24 which assigns the received desired speed “ref_speed” to the “set_speed” function, i.e. “set_speed(ref_speed)”. The interface software module 24 transmits the reference speed “ref_speed” to the compiled module 32 which determines the powering conditions for the electric motor corresponding to the reference speed “ref_speed”. PWM command signals indicative of the determined powering conditions are transmitted to the power converter 16 which powers the electric motor 12.

In one embodiment, the compiled module 32 further comprises at least one debugging function. The debugging function may be designed for testing a piece of equipment of the system 10.

In one embodiment, the motor control software component 30 further comprises a user-defined function module 36. The user-defined function module 36 comprises at least one function that can be accessed by the user of the motor control software component 30, i.e. the designer of the embedded system 14. For example, in an embodiment in which the system 10 comprises at least one sensor/transducer 19, the user-defined function module 36 may comprise at least one sampling pre-defined function for mapping the sensor measurements into software program registers. The sampling pre-defined function are used for converting the format of the monitored parameter determined by the sensor into an adequate format used in the control functions contained in the compiled module 32. The sampling pre-defined function can be accessed and modified by a designer of the power electronic system to adapt the user-defined function to his particular sensor/transducer and allow the functions contained in the compiled module 32 to be independent from the particular sensor/transducer used in the power electronic system.

FIG. 4 illustrates one embodiment of a method 40 for designing a control software product for integration with a main application of an embedded system adapted to control a power electronic converter such as an inverter for example. The power converter is contained in a power electronic system such as system 10 for example, and the embedded system is used for controlling at least the power electronic device of the power converter.

At step 42, software source code comprising a control algorithm is generated. The control algorithm is specific to the power converter topology, the power converter load and the application of the power converter load to be controlled. Furthermore, the control algorithm comprises at least one control function for determining operation parameters of the power converter.

For example, the power converter 16 to be controlled may be a two-level three-phases inverter used for powering the electric motor 12 such as a three-phases Permanent Magnet Synchronous Motor (PMSM) in an application-specific power electronic system 10 such as an industrial servo-drive system. In this case, the state of the electric motor 12, is to be controlled, i.e. the torque, the rotor shaft speed, the rotor shaft position and/or the like are to be controlled, and the control algorithm comprises at least one function for determining the powering conditions for the electric motor according to a desired state for the electric motor 12. In this case, the algorithm is specific to the topology of the power converter 16, which is the powering of the electric motor 12 in an application-specific power electronic system 10.

At step 44, the software source code is compiled to obtain a compiled file. Alternatively, the source code is encrypted so as to be unreadable to the designer of the embedded system.

At step 46, a software interface for interfacing the compiled file obtained at step 44 with the main application of the embedded system is generated. For example, the software interface may be an API. The software comprises a definition of the different functions contained in the compiled file so that the functions may be called by the main application. The software interface allows for the communication between the main application and the functions contained in the compiled file.

In one embodiment, the method 40 further comprises generating an open code file comprising second software source code corresponding to user-defined functions. The source code contained in the open code file is open to the designer of the embedded system so that the user-defined functions may be generated and/or modified by the designer of the embedded system.

In one embodiment, the user-defined functions are specific to the components of the system 10 that may change from one designer to another while using a same power electronic component. For example, the user-defined functions can be specific to the sensors/transducers used in the power electronic system, which may change from one implementation to another. For example, if a particular application of the power converter 16, such as powering the electric motor 12, requires a temperature sensor for monitoring the temperature of a component of the power electronic system, then a user-defined function specific to the temperature sensor may be included in the user-defined function module 36. For example, a user-defined function may be used for mapping the values of the monitored temperature, which depend on the particular temperature sensor used in the system 10, into program registers.

In one embodiment, the functions contained in the compiled module 32 are specific to the particular application of the power converter, such as powering an electric motor 12 for example. Therefore, the functions contained in the compiled module 32 are specific to the particular motor 12 and the application for the particular motor 12.

In one embodiment, the power converter control software component 30, i.e. the compiled module 32, the interface software module 34, and the user-defined function module if any, are provided to a designer of the embedded system 14. The designer of the embedded system creates the main application software component 28 and integrates at least some of the functions defined in the interface software module 34 to call these functions which are contained in the compiled module 32.

In one embodiment, the power converter control software component 30 is stored on a storage unit, and the storage unit is provided to the designer of the embedded system.

In one embodiment, since the functions contained in the compiled module 32 are specific to the application of the power converter 16 and the electric motor 12, the designer of the embedded system 14 does not have to adapt these functions to his particular power electronic system. Therefore, the designer does not have to possess particular skills/expertise in the application of the power converter and electric motor, such as motor control used in pump and fan systems for example. If the power electronic system 10 comprises elements specific to the designer implementation such as a temperature sensor for example, the designer then creates a mapping function in the user-defined function module 36 in order to map the temperature sensor and the functions using the monitored temperature and contained in the compiled module 32 together. Since two temperature sensors may communicate the monitored temperature using different data format, the designer creates a user-defined function for converting the data format into a format that is understood by the compiled module 32. For example, a first temperature sensor may output a 1 mA current for indicating that the monitored temperature is equal to 20° C. while a second and different temperature sensor may output a 3 mA current which corresponds to the same temperature, i.e. 20° C. In this case, the 1 mA or 3 mA current value is received by the main application software component 28 which transmits it to the compiled module 32. The compiled module 32 then calls the user-defined function in order determine the corresponding temperature value. In a system comprising the first temperature sensor, the user-defined function converts the 1 mA current value into a 20° C. temperature value, while it converts the 3 mA current value into the same 20° C. temperature value in a system comprising the second temperature sensor.

In one embodiment, since the control functions are contained in the compiled module 32, the designer does not have access to the code contained therein, which allows for protecting the Intellectual Property (IP) work of the person who developed the control algorithm and coded the control and system debug functions.

While the present description refers to a compiled software module 32 comprising compiled code, it should be understood that any adequate method for preventing a designer of the embedded system from accessing the code contained in the software module 32 may be used. For example, the software module 32 may comprised encrypted code and any adequate method for encrypting the code contained in the module 32, and therefore making it unreadable to a designer of the embedded system, may be used. In this case, the step 44 comprises encrypting the code.

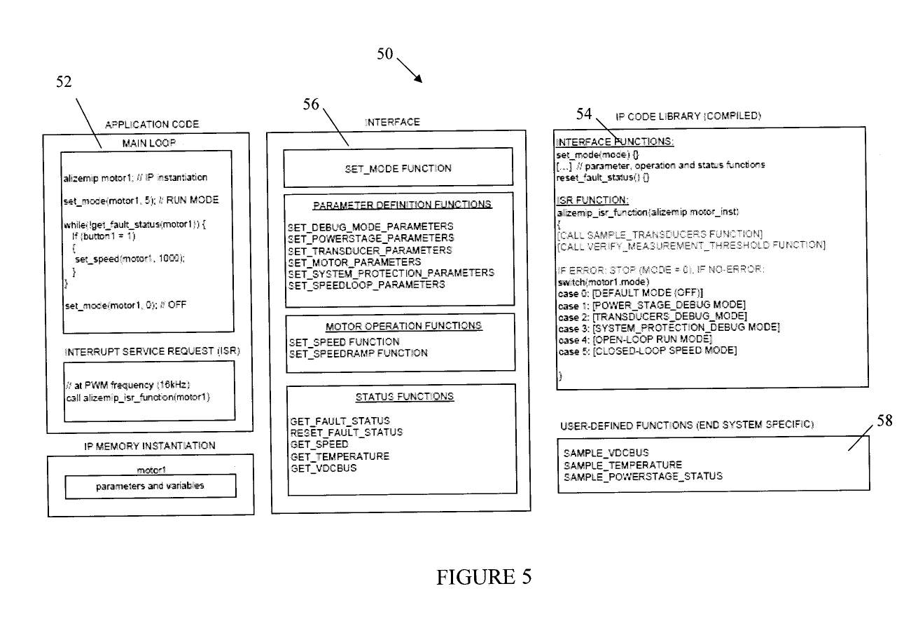

In one embodiment, the source code generated at step 42 comprises functions other than control functions such as monitoring functions, fault detection and fault diagnosis functions for example, as described below with respect FIGS. 5, 7, and 8. For example, the source code contained in the compiled module 32 may comprise a temperature monitoring function which compares the monitored temperature to a temperature threshold. If the temperature reaches the threshold, then an alarm is triggered and/or an action is undertaken.

FIG. 5 illustrates one embodiment of a power converter control software component 50 for controlling an electric motor driving a low-dynamic load such as a pump or a fan. The power converter control software component 50 comprises a compiled library 54, an interface software module 56, and a user-defined function module 58. The power converter control software component 50 is in communication with a main application software component 52 which controls the operation of a power electronic system comprising at least an electric motor driving a pump or a fan and a power converter powering the electric motor.

The main application software component 52 comprises a main loop and an Interrupt Service Request (ISR) routine that are both created by the designer of the embedded system for controlling the electric motor. The compiled library 54, the interface 56, and the user-defined functions are all provided to the designer who integrates them with his main application.

The compiled library 54 comprises interface functions, i.e. a function for setting the operation mode for the electric motor, parameters definition functions, motor operation functions, and status functions, which are all specific to the application of the electric motor, i.e. driving a pump or a fan load for example. All of these functions are defined in the interface 56 and may be called by the designer of the system in the main loop of the main application.

The “set mode” function is used for setting an operation mode for the power electronics system. For example, different modes may exist for the operation of the power electronics system, e.g. a default or off mode, a power stage debug mode, a transducer debug mode, a system protection debug mode, an open-loop run mode, and a closed-loop debug mode. The parameter definition functions are functions that may be called for setting parameters. For example, the interface 56 may comprise a function for setting parameters used in the debug mode, a function for setting parameters of the power stage (power converter), a function for setting the parameters of transducers or sensors, a function for setting parameters for the system protection, and a function for setting speed-loop parameters.

The motor operation functions may comprise a function for setting the speed of the electric motor and a ramp function for setting the speed of the motor. The status functions may comprise a function for obtaining the fault status, a function for resetting the fault status, a function for obtaining the speed of the electric motor, a function for obtaining the temperature, and a function for obtaining the DC bus voltage at the input of the power converter.

The compiled library 54 further comprises ISR functions which are periodically called by the ISR routine contained in the main application 52. For example, the ISR functions may be called at a frequency of 4 kHz. For each mode described above, a corresponding ISR function is contained in the compiled library 54. The ISR function is used for determining the powering conditions of the electric motor driving a pump or a fan load, i.e. the output of the power converter.

The user-defined function module 58 comprises functions that are to be created and/or modified by the designer. As described above, the user-defined functions comprise functions that convert data format. The power electronic system comprises a temperature sensor for monitoring the temperature of a piece of equipment such as the electric motor for example, a voltage transducer for monitoring the DC bus voltage at the output of the power converter which is also adapted to communicate its status. For example, the user-defined functions may comprise a “sample_VDCBUS” function for converting the format of the monitored DC bus voltage a sample temperature function for converting the format of the monitored temperature, a sample power stage or power converter status function, etc.

The user-defined functions are called by the ISR functions in order to obtain the monitored temperature, the monitored DC bus voltage, the monitored power stage status, etc, in an adequate data format, and these parameters are used by the ISR functions in order to determine the powering conditions for the electric motor.

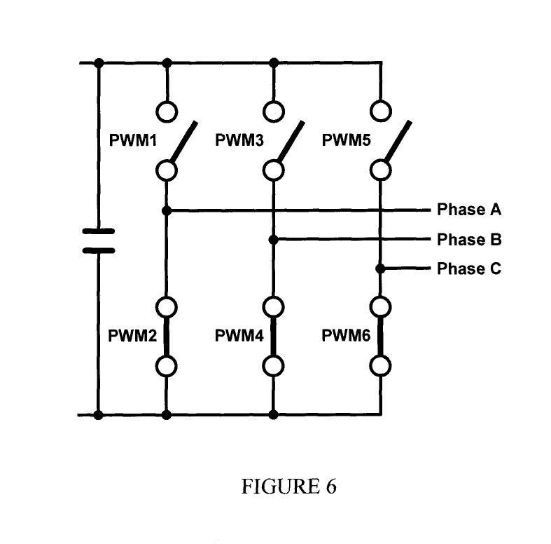

In one embodiment, the power converter comprised in the power electronic system controlled by the power converter control software component 50 is a three phase two-level inverter such as the one illustrated in FIG. 6.

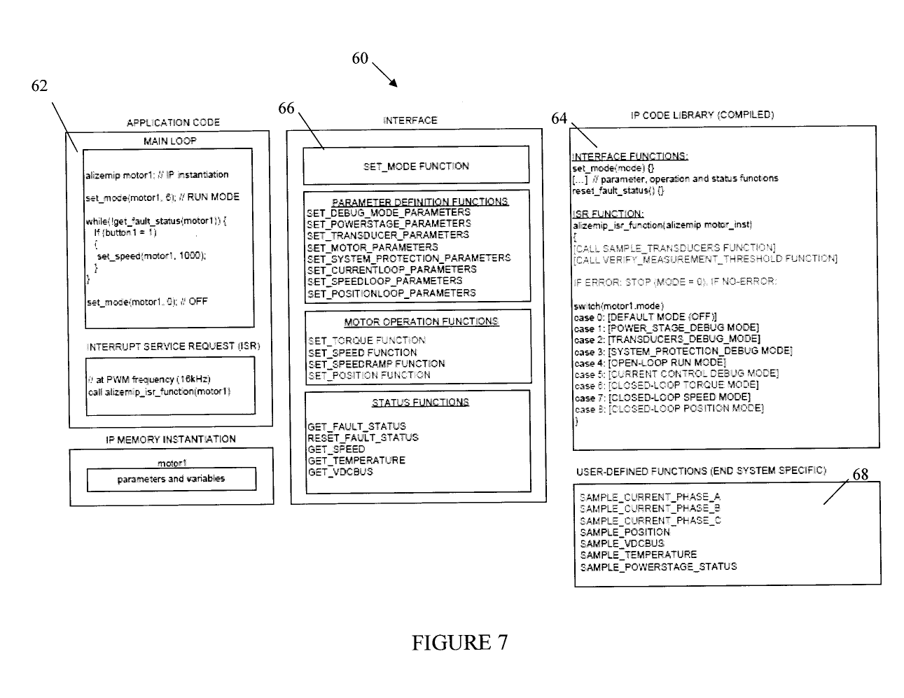

FIG. 7 illustrates one embodiment of a power converter control software component 60 for controlling a single motor used in a servo-drive application. The power converter control software component 60 comprises a compiled library 64, an interface software module 66, and a user-defined function module 68. The power converter control software component 60 is in communication with a main application software component 62 which controls the operation of the power electronic system comprising at least the single electric motor and a power converter for powering the single electric motor.

As for the main application software component 52, the main application software component 62 comprises a main loop and an ISR routine that are both created by the designer of the embedded system for controlling the single electric motor. The compiled library 64, the interface 66, and the user-defined functions 68 are all provided to the designer who integrates them in the main application.

In the present case, the power electronic system further comprises a two current sensors and a position sensor for measuring the phases currents and the rotor shaft position for the electric motor, respectively.

With respect to the compiled library 64, the compiled library further comprises a “set_torque” function and a “set_position” function which are used for setting the torque and the position of the electric motor to desired values, respectively. These two functions are further defined in the interface 66.

The compiled library 64 further comprises a verify measurement threshold function contained in the ISR function. The purpose of this test function is to verify that previously sampled transducers are providing measurements that are within the threshold previously defined by the designer. If a measurement is outside a predefined threshold, the operation of the system automatically gets back to Mode 0 (off) and a corresponding fault status flag is set. If a measurement is inside predefined threshold, the operation continues normally. For example, if the maximum temperature threshold has been defined to 100° C. and the sampling temperature function is returning a value of 110° C., then the operation of the system is set back to Mode 0 (default mode in which power stage is off) and a temperature status flag is set. If this function returns 90° C., the operation continues normally.

The user-defined functions 68 further comprise a sample current phase A function, a sample current phase B function, a sample current phase B function, and a sample position function for mapping the format of the monitored position.

The purpose of a sample current phase function is to sample transducer information (from analog-to-digital converter or from sigma-delta converter or from any other type of converter) and to process it in order to be usable by the control system.

The required steps comprise:
1—Read converter output;
2—Apply zero-offset; and
3—Apply scaling gain.

It should be understood that other steps may be necessary to obtain desired information formatting depending on the system implementation details.

The user-defined functions are called by the functions contained in the compiled library 64 to determine monitored parameters. The compiled library 64 further comprises an ISR function for a current loop run mode, a closed loop torque mode, and a closed-loop position mode.

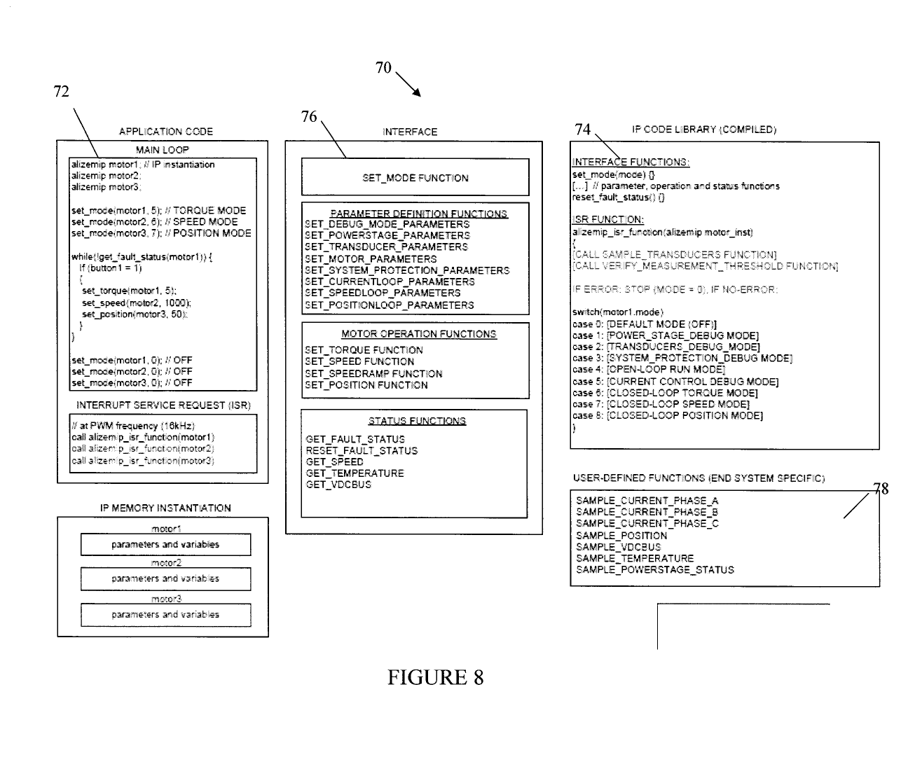

FIG. 8 illustrates one embodiment of a power converter control software component 60 for controlling three motors used in a servo-drive application. The power converter control software component 70 comprises a compiled library 74, an interface software module 76, and a user-defined function module 78. The power converter control software component 70 is in communication with a main application software component 72 which controls the operation of the power electronic system comprising at least the three electric motors and three power converters for powering a respective one of the three electric motors.

As for the main application software component 52, the main application software component 72 comprises a main loop and an ISR routine that are both created by the designer of the embedded system for controlling the single electric motor. The compiled library 74, the interface 76, and the user-defined functions 78 are all provided to the designer who integrates them in the main application.

It should be understood that each electric motor is provided a respective set of sensors and a power converter.

With respect to the main application 62, the main application 72 allows for defining an operation mode for each motor and the ISR request is used for calling an ISR function for each motor. It should also be understood that parameters and variables are defined for each motor.

The interface 76 is substantially the same as the interface 66. The functions contained in the compiled library 74 and the user-defined functions are substantially the same as those illustrated in FIG. 7. For example, the interface 76 comprises an identification of each motor so that adequate parameters and variables corresponding to a respective motor be used.

With respect to the compiled library 64, the compiled library 74 further comprises a set torque function and a set position function which are used for setting the torque and the position of the electric motor to desired values, respectively. These two functions are further defined in the interface 76.

The user-defined functions 78 further comprise a sample current phase A function, a sample current phase B function, a sample current phase C function, and a sample position function for mapping the format of the monitored position.

The description below presents different operation mode including the different debug modes that are used by the designer while creating its main application loop.

In one embodiment, the designer uses the power converter debug mode in order to toggle between all possible states of the power converter and verify that the phase voltage output of the power stage corresponds to predefined values. In the case of a three phase and two-level inverter as illustrated in FIG. 6, eight states are possible for the power stage.

The test in the power stage debug mode begins at state 0 and upon designer input (e.g. pressing a button), the power stage state is changed to state 1, 2 . . . 7 then to 0 again. At each state, the designer of the embedded system can verify the voltage between the phase output and neutral (VAn, VBn, VCn) as illustrated in the following Table 1:

TABLE 1
Voltage between the phase output and neutral as a function
of the power stage state.

| State | VAn | VBn | VCn |
|---|---|---|---|
| 0 | 0 | 0 | 0 |
| 1 | VDC | 0 | 0 |
| 2 | VDC | VDC | 0 |
| 3 | 0 | VDC | 0 |
| 4 | 0 | VDC | VDC |
| 5 | 0 | 0 | VDC |
| 6 | VDC | 0 | VDC |
| 7 | VDC | VDC | VDC |

Then the designer can toggle between two states (e.g. state 0 and 4 for example) at a desired frequency to verify that the power stage commutes properly and that the dead time mechanism also operates adequately.

It should be understood that the power stage debug mode must be done with no load attached to the power stage. A safety message and a confirmation may be asked to the designer before entering into the power stage debug mode.

In one embodiment, while creating the main application, the designer uses the transducer debug mode in order to verify that:
1—transducers are properly operating and connected to the power electronic system; and
2—information provided by transducers measurements are correctly mapped into software program registers.

A same test procedure may be used for any type of transducer (current, voltage, position, temperature, etc.), and the procedure is the following:
1—adjust the zero offset;
2—adjust the gain offset based on maximum transducer range and software register resolution; and
3—verify that sign handling is correct (if applicable).

In the case of a phase current transducer such as phase A current transducer (applicable to any signed measurement), the first step consists in adjusting the zero offset. While the power stage is at state 0 (i.e. no current is flowing in phase A), the value returned by the sample phase A function should be (in the case of a 16 bit register)=2¹⁶/2=32768. Secondly, while the power stage is at state 0, the designer must inject some current (e.g. 1 Ampere) into phase A (flowing out via phase B or C) using any adequate current source. The value returned by the sample phase A function should be equal to: Value=32768+1*0.95*2¹⁶⁻¹/(maximum current value). If the maximum current value is 10 Ampere, then the value returned by the function should be 35881. The second step is repeated while injecting −1 Ampere. The function output value should then be equal to 29655.

At each step, if the function returns something else than indicated, the function definition must be corrected accordingly by the designer. The designer then recompiles the application with corrected function and tests again.

In the case of a position sensor (applicable to any unsigned measurement), the first step consists in ensuring that the rotor mechanical position is at angle 0 DEG using any adequate methods. The value returned by the sample position should be equal to 0. Secondly, a half-turn rotation is applied on the rotor of the electric motor which should be at 180 DEG. The value returned by the sample position function should be equal to: 2¹⁶*(180/360)=32768, for a 16 bit register.

At each step, if the function returns a value different from the above values, the function definition must be corrected accordingly by the designer. The designer then recompiles the application with corrected function and performs a further test.

In one embodiment, the transducer debug mode is performed with NO LOAD attached to the power stage. A safety message and a confirmation may be asked to the designer before entering into this mode.

In the case of a temperature sensor, the first step of the test is the following. While system is at ambient temperature, the value returned by the sample temperature function should be (in the case of a 16 bits register)=ambient temp*2̂16/(max temp−min temp).

For example, if the ambient temperature is about 25° C., the maximum temperature, and the minimum temperature are about 25° C., 100° C., and 0° C., respectively, then the temperature value at ambient temperature returned by the sample temperature function should be 16384.

The second step consists in performing tests at different ambient temperature (e.g. initial ambient +/−10° C.) to assess that the temperature transducer is operating properly.

At each step, if the function returns something else than indicated, the function definition must be corrected accordingly by the designer of the embedded system. The designer then recompiles the application with corrected function and tests the system again.

In one embodiment, the designer uses the system protection mode in order to verify that:
1—the system protection mechanisms are properly working; and
2—the fault threshold limits are correctly set.

The test procedure may be the same for each protection mechanism (over current, over temperature, over DC bus voltage, etc.).

In one embodiment, for each type of fault, two thresholds may be set, i.e. a warning threshold and a fault threshold. Once the warning threshold is reached, a warning fault is flagged but the system continues to operate normally. Once the fault threshold is reached, the system mode is set to 0 (OFF).

For example, the test for the DC bus voltage V_{DCBUS} may be the following. First, the warning threshold and the fault threshold are set using the set system protection parameters function with test values. Then, the voltage V_{DCBUS} is gradually increased up to the warning threshold and it is verified that the warning fault is properly flagged.

Then, the voltage V_{DCBUS} is gradually increased up to the fault threshold and it is verified that the system is properly set back to mode 0 once the fault threshold has been reached.

In one embodiment, the open-loop run mode is used by the designer to verify that:
1—the power stage is operating properly;
2—the control transducers are operating adequately; and
3—the speed estimation for the electric motor is adequate (if applicable).

In one embodiment, the test procedure consists in applying a sine voltage wave on the motor phases by setting successively setting power stage state from 1 to 6 (commonly known as the six-step method).

First, the frequency of the sine voltage wave (i.e. the time to pass through the six steps) is set using the set debug mode parameters function. Then, the voltage is set incrementally from 0.1 to 0.5 of power converter nominal voltage with 0.1 increases upon the designer pressing a button. Once the motor is running, the designer can verify that the speed estimation based on rotor shaft position signal is properly working in the whole range of operation using an external speed sensor.

In one embodiment, the current control debug mode is used by the designer to verify that the current control loop of a vector-control based motor control scheme is operating properly (not necessarily optimized) by correctly producing mechanical torque on the motor's rotor. The two following steps are performed.

First step: while the torque command is set to zero, the designer verifies that no torque is produced on rotor while the rotor is at standstill (no acceleration). The designer also verifies the same while the rotor is rotating in both directions (by having torque applied from an external source).

Second step: while the torque command is set to a positive value (e.g. 1 Nm), the designer verifies that the rotor accelerates and rotates clockwise. While the torque command is set to a negative value (e.g. −1 Nm), the designer verifies that the rotor accelerates and rotates counter clockwise.

At each step, if the motor behaves differently than indicated, the designer identifies the problem and applies correction. The designer then recompiles the application and test again.

### Sample_Transducer Function

In one embodiment, the sample transducer function is used by the designer to call the user-defined sample transducer function at the beginning of the ISR function in order to use those measurements further therein for control, monitoring or system protection purposes. For example, in the case of the servo-drive application, the following test functions may be called:
1—SAMPLE_CURRENT_PHASE_A
2—SAMPLE_CURRENT_PHASE_B
3—SAMPLE_CURRENT_PHASE_C
4—SAMPLE_POSITION
5—SAMPLE_VDCBUS
6—SAMPLE_TEMPERATURE
7—SAMPLE_POWERSTAGE_STATUS

Measurements may be sampled at different frequencies to optimize computing power. Also, filtering may be applied to measurements to filter noise in order to provide clean signals to control algorithms (better control) or to system protection algorithms (fewer false alarms).

It should be understood that the ISR functions corresponding to closed-loop modes are used for determining the powering conditions during operation of the power electronic system while the debug functions are used by the designer prior to operation of the power electronic system while designing the main application.

For example, the ISR function corresponding to the closed-loop speed mode allows for determining the powering conditions according to a desired speed for the rotor of the electric motor. In another example, the ISR function corresponding to the closed-loop position mode allows for determining the powering conditions according to a desired position for the rotor of the electric motor. In a further example, the ISR function corresponding to the closed-loop torque mode allows for determining the powering conditions according to a desired torque applied on the rotor of the electric motor.

In one embodiment, the compiled library 54, 64, 74 further comprises an “auto-shut off” function adapted to automatically turns off the system by returning to Mode 0 (off) after a predetermined amount of time defined by the designer of the embedded system. By verifying that this feature is working properly before doing load tests, the designer guarantees that if any problem occurs during motor operation, system is going to shut off after a pre-set amount of time.

It should be understood that the processing unit 24 can be any adequate device adapted to execute software programs on an embedded system, including any microprocessor, coprocessor, peripheral, logic or the like included on the device. For example, the processing unit 24 may be a processor, a microprocessor, a Digital Signal Processor (DSP), a Microcontroller Unit (MCU), a Field-Programmable Gate Array (FPGA), an Application-Specific Integrated Circuit (ASIC), or the like.

It should be understood that the memory unit 26 may be included within the processing unit 24 or may be external of processing unit 24 dependant on system implementation details.

It should be understood that the functions contained in the compiled module or library are specific to the power converter topology and the application of the load powered by the power converter. In the case of a power converter for powering an electric motor, the functions contained in the compiled module or library are specific to the application of the electric motor, and therefore specific to the given electric motor and the given application of the given electric motor. For example, a same power converter and electric motor may be used in completely different application such has a vehicle power steering and washing machine. The set of functions contained in the compiled module or library for both applications are not going to be exactly the same.

It should be understood that this software may be used to control a virtual power converter and or a virtual electric motor which software model is running in real time on the same device or onto another device or system.

It should be understood that this method applies to any embedded software development environment and/or Electronic Design Automation (EDA) tools which are commercially available to develop embedded system software and or to configure Programmable Logic Devices (PLD). Those tools may be provided by device vendor or may be offered by third-party companies. Those tools may allow embedded software development in languages such as assembly, C or C++ or via graphical methods such as Matlab™/Simulink™ or National Instruments LabView™. In the case of graphical methods, the software code is automatically generated for the graphs.

While the present description refers to a power converter for powering an electric motor, it should be understood that the power converter may have other applications. For example, the power electronic system may be an electrical energy generation system connected to a grid for powering the grid. For example, the electrical energy generation system may comprise a solar power system adapted to convert solar energy into electrical energy, a wind turbine system adapted to convert kinetic energy from the wind into mechanical energy and subsequently the mechanical energy into electrical energy, or the like.

The electrical energy generation system further comprises a power converter for converting the DC current generated by the solar power system, the wind turbine system, etc, into adequate AC current for powering the grid. In this case, the compiled module comprises the functions for controlling the power converter in order to provide the grid with adequate AC voltage, AC current intensity, AC current frequency, and/or the like. The functions contained in the compiled module are specific to the application of the power converter, i.e. powering the grid, and therefore specific to the grid itself.

User-defined functions, if any, are included in a user-defined function module and are used for adapting the specificities of the solar power system, the wind turbine system, etc, to the generic control functions.

While in the present description they are protected, e.g. compiled or encrypted, it should be understood that the module 32 and the library 54, 64, 74 may be open so that a designer of the embedded system may access the code contained therein.

The embodiments described above are intended to be exemplary only. The scope of the invention is therefore intended to be limited solely by the scope of the appended claims.

1. A method for designing a control software product for integration with a main software application of an embedded system adapted to control a power converter in a power electronic system, the method comprising:
generating software source code comprising a control algorithm being specific to a topology of the power converter, a power converter load, and an application of the power converter load, the control algorithm comprising at least one control function for determining a state for the power converter according to a desired parameter;
compiling or encrypting the software source code, thereby obtaining a compiled file;
generating a software interface for interfacing the compiled file with the main application, the software interface file comprising a definition of the at least one control function; and
outputting the compiled file and the software interface.

2. The method of claim 1, wherein the power converter is an inverter.

3. The method of claim 1, wherein the application of the power converter comprises powering an electric motor, the control algorithm being specific to the electric motor and an application of the electric motor.

4. The method of claim 3, wherein the desired parameter is specific to the electric motor.

5. The method of claim 3, wherein the desired parameter comprises one of a speed, a position, a torque, and an acceleration.

6. The method of claim 1, further comprising generating an open code file comprising second software source code corresponding to user-defined functions specific to the power electronic system, the second software source code being modifiable by a user to adapt the user-defined functions to the power electronic system.

7. The method of claim 6, wherein the power electronic system comprises at least one sensor for monitoring at least one operating parameter, the user-defined functions being specific to the at least one sensor.

8. The method of claim 1, wherein said software source code comprises a function for automatically shutting off the power electronic system after a predetermined period of time.

9. An embedded system for controlling a power converter in a power electronic system, comprising:
a processing unit; and
a memory having stored therein:
a compiled file comprising a control algorithm being specific to a topology of the power converter, a power converter load, and an application of the power converter load, the control algorithm comprising at least one control function for determining a state for the power converter according to a desired parameter;
a main application for receiving the desired parameter and outputting the determined state for the power converter; and
a software interface for interfacing the compiled file with the main application, the software interface file comprising a definition of the at least one control function.

10. The embedded system of claim 9, wherein the power converter is an inverter.

11. The embedded system of claim 9, wherein the application of the power converter comprises powering an electric motor, the control algorithm being specific to the electric motor and an application of the electric motor.

12. The embedded system of claim 11, wherein the desired parameter is specific to the electric motor.

13. The embedded system of claim 11, wherein the desired parameter comprises one of a speed, a position, a torque, and an acceleration.

14. The embedded system of claim 9, further comprising an open code file comprising second software source code corresponding to user-defined functions specific to the power electronic system, the second software source code being modifiable by a user to adapt the user-defined functions to the power electronic system.

15. The embedded system of claim 14, wherein the power electronic system comprises at least one sensor for monitoring at least one operating parameter, the user-defined functions being specific to the at least one sensor.

16. An embedded system for controlling a power converter in a power electronic system, comprising:
a processing unit; and
a memory having stored therein:
first software code comprising a control algorithm being specific to a topology of the power converter, a power converter load, and an application of the power converter load, the control algorithm comprising at least one control function for determining a state for the power converter according to a desired parameter;
second software code comprising at least a test function for testing at least one property of the power electronic system;
a main application for receiving the desired parameter and outputting the determined state for the power converter; and
a software interface for interfacing the compiled file with the main application, the software interface file comprising a definition of the at least one control function.

17. The embedded system of claim 16, wherein the application of the power converter comprises powering an electric motor, the control algorithm being specific to the electric motor and an application of the electric motor.

18. The embedded system of claim 17, wherein the desired parameter is specific to the electric motor.

19. The embedded system of claim 17, wherein the desired parameter comprises one of a speed, a position, a torque, and an acceleration.

20. The embedded system of claim 16, further comprising open software source code corresponding to user-defined functions specific to the power electronic system, the open software source code being modifiable by a user to adapt the user-defined functions to the power electronic system.
